(19) United States
(12) Patent Application Publication
(10) Pub. No.: US 2026/0119684 A1
(43) Pub. Date: Apr. 30, 2026

(54) ANSWER GENERATION METHOD AND NON-TRANSITORY COMPUTER READABLE MEDIUM

(71) Applicant: TOYOTA JIDOSHA KABUSHIKI KAISHA, Toyota-shi (JP)

(72) Inventor: Hideki KAWAI, Edogawa-ku (JP)

(73) Assignee: TOYOTA JIDOSHA KABUSHIKI KAISHA, Toyota-shi (JP)

(21) Appl. No.: 19/352,731

(22) Filed: Oct. 8, 2025

(30) Foreign Application Priority Data
Oct. 24, 2024 (JP) 2024-187773

(51) Int. Cl. G06F 21/62; G06F 16/3329; G06F 40/279

(52) U.S. Cl. CPC G06F 21/62; G06F 16/33295; G06F 40/279

(57) ABSTRACT

An answer generation method includes determining whether an input question corresponds to a question regarding non-public information, in a case in which the input question is determined to correspond to a question regarding non-public information, acquiring information on a non-public information storage location as an answer to the input question, in a case in which the input question is determined not to correspond to a question regarding non-public information, acquiring at least one piece of document data related to the input question from a database in which a plurality of pieces of document data is stored, generating a prompt to be input into interactive AI based on the input question and the at least one piece of document data inputting the prompt into the interactive AI, and acquiring output from the interactive AI as an answer to the input question, and displaying the acquired answer.

### CROSS-REFERENCE TO RELATED APPLICATION

This application claims priority to Japanese Patent Application No. 2024-187773 filed on October 24, 2024, the entire contents of which are incorporated herein by reference.

### TECHNICAL FIELD

The present disclosure relates to an answer generation method and an answer generation program.

### BACKGROUND

Patent Literature (PTL) 1 discloses technology for generating, based on a given technical field, a dialogue bot specialized for the technical field using a large language model (LLM).

### CITATION LIST

### Patent Literature

PTL 1: JP 2023-076413 A

### SUMMARY

By further utilizing retrieval augmented generation (RAG) using the LLM, which is generated by machine learning, to the technology disclosed in PTL 1, interactive AI may be provided using non-public information accumulated in a database of an in-house system or the like as a data source. However, providing the non-public information to the interactive AI is undesirable from a security perspective.

It would be helpful to provide an answer generation method that utilizes RAG while preventing non-public information from being leaked to outside parties.

A method according to an embodiment of the present disclosure includes: determining whether an input question corresponds to a question regarding non-public information; in a case in which the input question is determined to correspond to a question regarding non-public information, acquiring information on a non-public information storage location as an answer to the input question; in a case in which the input question is determined not to correspond to a question regarding non-public information: acquiring at least one piece of document data related to the input question from a database in which a plurality of pieces of document data is stored; generating a prompt to be input into interactive AI based on the input question and the at least one piece of document data; inputting the prompt into the interactive AI; and acquiring output from the interactive AI as an answer to the input question; and displaying the acquired answer.

According to the present disclosure, it is possible to generate answers utilizing RAG while preventing non-public information from being leaked to outside parties.

### BRIEF DESCRIPTION OF THE DRAWINGS

In the accompanying drawings:

FIG. 1 is a block diagram illustrating a configuration of an answer generation system according to an embodiment of the present disclosure; and

FIG. 2 is a flowchart illustrating example operations of the answer generation system according to an embodiment of the present disclosure.

### DETAILED DESCRIPTION

An embodiment of the present disclosure will be described below, with reference to the drawings. In the drawings, portions having the same configuration or function are denoted by the same reference numerals. In the description of the present embodiment, duplicate descriptions of the same portions are in some cases omitted or simplified, as appropriate.

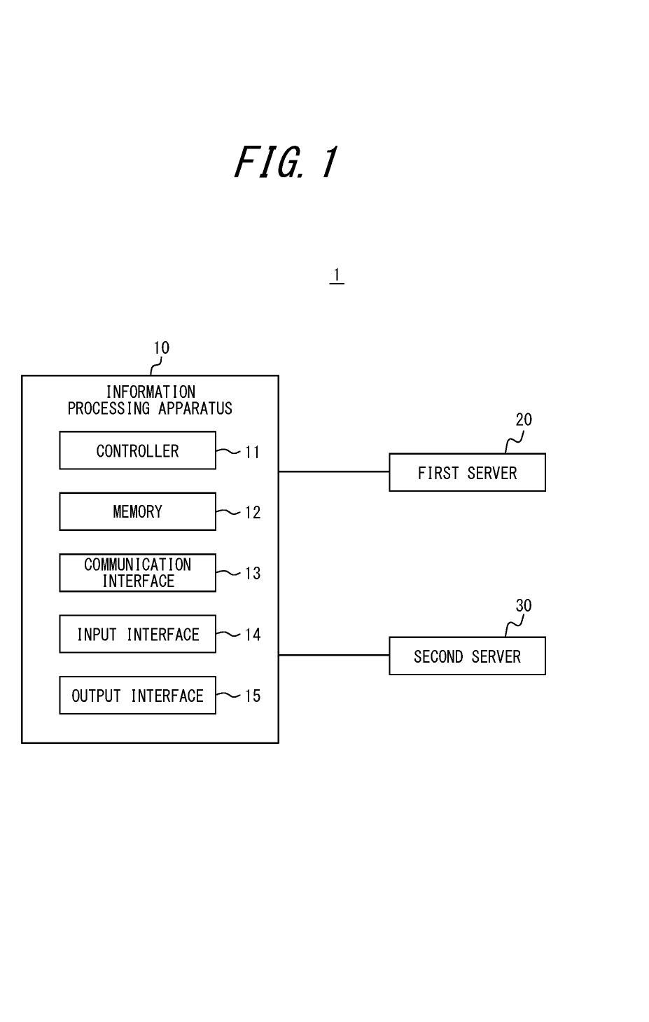

A configuration of an answer generation system 1 according to an embodiment of the present disclosure will be described with reference to FIG. 1.

The answer generation system 1 is equipped with an information processing apparatus 10, a first server 20, and a second server 30.

The information processing apparatus 10 includes a controller 11, a memory 12, a communication interface 13, an input interface 14, and an output interface 15. The information processing apparatus 10 is a general purpose computer, such as a workstation, PC, smartphone, tablet, etc. The information processing apparatus 10 accepts a question from a user, determines whether the question is a question regarding non-public information, and generates an answer to the question after receiving appropriate information from the first server 20 and the second server 30.

The controller 11 includes one or more processors, one or more dedicated circuits, or a combination of these, and performs the prescribed processing. The processor is a general purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 11 executes various processes related to the operations of the information processing apparatus 10 and controls various parts of the information processing apparatus 10.

The memory 12 includes at least one semi-conductor memory, at least one magnetic memory, at least one optical memory, or a combination of at least two of these. The memory 12 stores data to be used for the operations of the information processing apparatus 10 and data obtained by the operations of the information processing apparatus 10. In one embodiment of the present disclosure, the memory 12 stores a record of dialogue between the information processing apparatus 10 and the second server 30. The memory 12 may also store sentence generation AI that generates sentences without communicating with the outside.

The communication interface 13 includes at least one interface for communication. The communication interface 13 receives data to be used for the operations of the information processing apparatus 10, and transmits data obtained by the operations of the information processing apparatus 10. In one embodiment of the present disclosure, the communication interface 13 communicates with the first server 20 and the second server 30 via a network.

The input interface 14 includes at least one interface for input. The interfaces for input are, for example, physical keys, capacitive keys, a pointing device, a touch screen integrally provided with a display, or a microphone that receives audio input. The input interface 14 accepts an operation for inputting information to be used for the operations of the information processing apparatus 10.

The output interface 15 includes at least one interface for output. The interface for output is, for example, a connection interface to an external or built-in display or external output device that outputs information as images and video. The display is, for example, a liquid crystal display (LCD) or an organic electro luminescent (EL) display. The output interface 15 outputs information obtained by the operations of the information processing apparatus 10.

The first server 20 is a server apparatus installed in a data center, for example. The first server 20 may be, for example, an in-house system that is not connected to the outside. The first server 20 is equipped with a database that aggregates the company's product information, including non-public information, and in-house information. The first server 20 transmits information or information on the information storage location to the information processing apparatus 10 in response to a request from the information processing apparatus 10.

The second server 30 is a server apparatus installed in a data center, for example. The second server 30 is equipped with generative AI. The second server 30 inputs the information, etc. received from the information processing apparatus 10 into the generative AI, generates sentences that serve as the answer, and transmits it to the information processing apparatus 10. The generative AI includes any interactive AI that uses LLM, for example.

The following is a description of an answer generation method according to one embodiment of the present disclosure.

Upon accepting a question from the user via the input interface 14, the controller 11 of the information processing apparatus 10 determines whether the question is related to non-public information. The determination method is not limited, but can be, for example, a method of checking whether the question text contains keywords regarding non-public information.

If the question is related to non-public information, the controller 11 of the information processing apparatus 10 searches for and extracts information regarding the question from the database provided by the first server 20. The controller 11 acquires information on the storage location of the extracted information from the first server 20. The storage location information can be, for example, a file path, link, URL, etc. The controller 11 then generates a sentence indicating that the answer to the question is information on the storage location, and outputs it to the output interface 15 as an answer to the question.

If the question is not related to non-public information, the answer generation system 1 will generate an answer to the input question utilizing the RAG. Specifically, the controller 11 of the information processing apparatus 10 searches the database provided by the first server 20 for information regarding the question and extracts one or more pieces of information. The information to be extracted is, for example, document data, but it is not limited to this and may be, for example, image data including text data. The controller 11 then creates a prompt based on the question that can be handled by the generative AI provided by the second server 30, and transmits it to the second server 30 together with the information acquired from the first server 20. The second server 30 generates answers using generative AI based on the prompt and information received from the information processing apparatus 10. The controller 11 of the information processing apparatus 10 outputs the answers received from the second server 30 to the output interface 15.

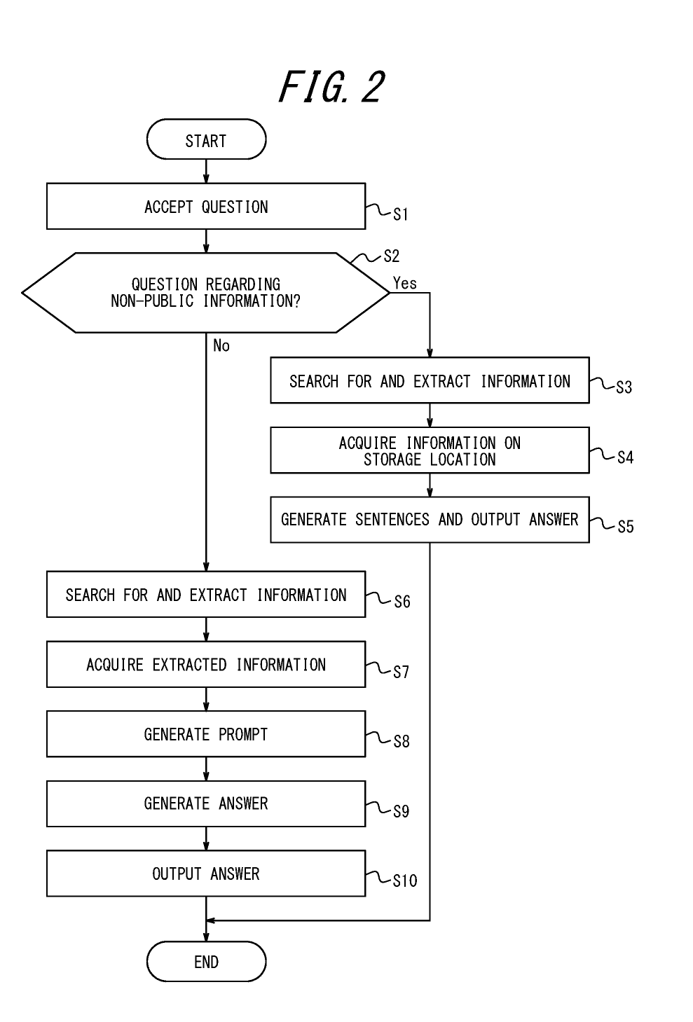

The following describes an answer generation method using the answer generation system 1 in accordance with one embodiment of the present disclosure with reference to FIG. 2. FIG. 2 is a flowchart illustrating an example of operations of the answer generation system 1 in accordance with one embodiment of the present disclosure.

In step S1, the controller 11 of the information processing apparatus 10 accepts a question from the user via the input interface 14. The controller 11 may accept questions in normal sentence form or in prompt form.

In step S2, the controller 11 of the information processing apparatus 10 determines whether the question accepted in step S1 is related to non-public information. For example, if the accepted question contains keywords that have been set in advance as those regarding non-public information, the determination method may determine that the question is related to non-public information. If the controller 11 determines that the question is related to non-public information (step S2: Yes), it proceeds to step S3. If the controller 11 determines that the question is not related to non-public information (step S2: No), it proceeds to step S6.

In step S3, the controller 11 of the information processing apparatus 10 searches for and extracts information related to the question accepted in step S1 from the database provided by the first server 20.

In step S4, the controller 11 of the information processing apparatus 10 acquires information on the storage location of the information extracted in step S3 from the first server 20.

In step S5, the controller 11 of the information processing apparatus 10 generates sentences indicating that the answer to the question accepted in step S1 is the information on the storage location acquired in step S4, outputs the sentences to the output interface 15 as an answer, and terminates the process. The sentences generated as an answer may be, for example, "This is non-public information. Please check <Information on Storage Location>.".

In step S6, the controller 11 of the information processing apparatus 10 searches for and extracts information related to the question accepted in step S1 from the database provided by the first server 20.

In step S7, the controller 11 of the information processing apparatus 10 acquires the information extracted in step S3 from the first server 20.

In step S8, the controller 11 of the information processing apparatus 10 generates a prompt that can be handled by the generative AI provided by the second server 30 based on the questions accepted in step S1. The controller 11 transmits the generated prompt and the information acquired in step S6 to the second server 30. The second server 30 receives the prompt and information from the information processing apparatus 10.

In step S9, the second server 30 inputs the prompt and information received from the information processing apparatus 10 into the generative AI to generate an answer. Upon generating the answer, the second server 30 transmits the answer to the information processing apparatus 10.

If the prompt and information received by the second server 30 in step S8 are insufficient to generate an answer, the second server 30 may query the information processing apparatus 10 for the missing information, etc. Upon receiving an inquiry from the second server 30, the controller 11 of the information processing apparatus 10 may generate a prompt or acquire the necessary information from the first server, which is the answer to the inquiry based on the question, and transmit it to the second server 30. The controller 11 of the information processing apparatus 10 may output an indication to the output interface 15 asking for a supplement to the question, if the question alone does not provide enough information to create a prompt that will serve as an answer to the query. When a supplement to the question is entered into the input interface 14, the controller 11 may generate a prompt or acquire the necessary information from the first server 20 based on the supplement and transmits it to the second server 30.

The controller 11 of the information processing apparatus 10 may supplement questions based on past records of dialogue with the interactive AI provided by the second server 30. The timing of the supplementation is not limited, but for example, the controller 11 of the information processing apparatus 10 may supplement the question at the timing of receiving the query from the second server 30.

In step S10, upon receiving the answer from the second server 30, the controller 11 of the information processing apparatus 10 outputs the answer to the output interface 15 and terminates the process.

By using the above method, the risk of non-public information being leaked to outside parties through the use of generative AI can be reduced, since answers to questions related to non-public information can be generated only through information sharing between the information processing apparatus 10 and the first server 20. On the other hand, for questions that are not related to non-public information, RAGs can be used to generate accurate answers in a short time.

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

If the first server is an in-house system, the controller 11 of the information processing apparatus 10 may search for and extract information that the in-house system stores outside the database.

1. An answer generation method performed by an information processing apparatus, the answer generation method comprising:
determining whether an input question corresponds to a question regarding non-public information;
in a case in which the input question is determined to correspond to a question regarding non-public information, acquiring information on a non-public information storage location as an answer to the input question;
in a case in which the input question is determined not to correspond to a question regarding non-public information:
acquiring at least one piece of document data related to the input question from a database in which a plurality of pieces of document data is stored;
generating a prompt to be input into interactive AI based on the input question and the at least one piece of document data;
inputting the prompt into the interactive AI; and
acquiring output from the interactive AI as an answer to the input question; and
displaying the acquired answer.

2. The answer generation method according to claim 1, wherein the information on the non-public information storage location is aggregated in the database.

3. The answer generation method according to claim 1, wherein the acquiring of the information on the non-public information storage location as an answer to the input question includes searching for and retrieving the information on the non-public information storage location from an in-house system to which the information processing apparatus is connected.

4. The answer generation method according to claim 1, further comprising:
storing a record of dialogue with the interactive AI; and
supplementing the input question based on the record of dialogue.

5. A non-transitory computer readable medium storing an answer generation program to cause an information processing apparatus to execute processing, the processing comprising:
determining whether an input question corresponds to a question regarding non-public information;
in a case in which the input question is determined to correspond to a question regarding non-public information, acquiring information on a non-public information storage location as an answer to the input question;
in a case in which the input question is determined not to correspond to a question regarding non-public information:
acquiring at least one piece of document data related to the input question from a database in which a plurality of pieces of document data is stored;
generating a prompt to be input into interactive AI based on the input question and the at least one piece of document data;
inputting the prompt into the interactive AI; and
acquiring output from the interactive AI as an answer to the input question; and
displaying the acquired answer.
